(19) United States
(12) Patent Application Publication
(10) Pub. No.: US 2007/0092669 A1
(43) Pub. Date: Apr. 26, 2007

(54) Packaging casing, in particular sausage casing containing a knitted fabric and method for opening said casing

(76) Inventor: Gebhard Rudolf Huckfeldt, Hamburg (DE)

Correspondence Address: ALIX YALE & RISTAS LLP, 750 MAIN STREET, SUITE 1400, HARTFORD, CT, 06103, US

(21) Appl. No.: 10/578,966

(22) PCT Filed: Nov. 2, 2004
(86) PCT No.: PCT/EP04/12382

§ 371 Date: May 10, 2006

(30) Foreign Application Priority Data
Nov. 11, 2003 (DE) 103 52 657.9

(51) Int. Cl. A22C 13/00; B65D 37/00

(52) U.S. Cl. 428/34.1; 138/118.1; 206/802

(57) ABSTRACT

A packaging casing, in particular sausage casing, which consists of knitted fabric or contains the latter as a strengthening constituent. It contains a seam which can be opened by means of a special release thread. In order to make this easier, the release thread is selected such that it loses its strength under the influence of a treatment compatible with the packaging contents or as the result of a time lapse. A method for opening such a packaging casing is distinguished in that the loss in strength of the release thread is brought about or awaited before opening.

The invention relates to a packaging casing, in particular sausage casing, which consists of knitted fabric or contains the latter as a strengthening constituent. It is, in particular, a casing net which surrounds a sausage outside the actual sausage casing, in order to give the sausage a particular shape. It may, however, also be the actual sausage casing (EP-B-106965) or a packaging casing for other products. The term “knitted fabric” is meant in this context in a most comprehensive sense. In particular, in connection with this invention description, it is also to include hosiery articles. The use of knitted fabric as a strengthening constituent has the advantage that the casing can yield with respect to forces concentrated at a point and therefore has particular resistance to such forces. The result of this, however, is also that it is not easy to tear the casing apart in order to open it.

A sausage casing is known (DE-U-9107065), having a longitudinal seam which is held together by means of a drawstring. This is a thread which can be drawn out of the seam in a longitudinal direction, with the result that the cohesion of the seam is broken and the casing can be drawn off from the contents. However, the drawstring runs in the seam in a zigzag-shaped manner and is therefore subjected, when it is being drawn out, to such a high frictional force that this can be carried out, in practice, only for very short seam portions and, moreover, depends on whether one end of the drawstring can be gripped, which, as a rule, is possible only with difficulty.

The invention seeks a way of making it easier to open the sausage casing. It is in this case aimed, in particular, at commercial processing, for example for the production of cold meats packaging units. For this purpose, it is important that the packaging casing can be released from the sausage or other packaging contents quickly and without any residue.

The invention achieves this aim in that the release thread is selected such that it loses its strength under the influence of a treatment compatible with the packaging contents or as a result of a time lapse. The method for opening the packaging casing, carried out by means of such a release thread, is distinguished in that, before opening, the loss in strength of at least one release thread contained in the knitted fabric is brought about or awaited. As long as the strength of the casing is required, for example in order to impart a specific configuration to the packaging contents, the release thread possesses the strength required for this purpose. Subsequently, its loss of strength is tolerated or is brought about deliberately in order to open the casing. The release thread or the method used for weakening it is selected such that only the release thread, but not the remaining casing, is affected, by the loss of strength. The remaining casing can thus be removed in the customary way after the opening of the seam. In a first group of implementation possibilities, the strength of the releasing method is reduced in a controlled way as soon as the casing is to be opened. If the selected release thread is temperature-sensitive, it is brought to the temperature necessary for the loss of strength. If it is, for example, thermoplastic, it is heated. If the material selected for the thread becomes brittle at low temperature, the thread is correspondingly cooled.

Where a thermoplastic thread is concerned, a thread material is selected, the softening temperature of which is sufficiently high above the temperature at which the sausage, as long as it is not yet dimensionally stable, is boiled, smoked or otherwise treated. If, for example, the treatment temperature is around 80° C., a thread material can be selected, the softening temperature of which lies in the range of 100 to 200° C., preferably in the range of 110 to 140° C. When the casing is to be opened, the thread or that region of the casing which contains the thread is heated to the softening temperature, and the casing is released. Furthermore, the softening temperature of the release thread is selected such that, during the short period of time in which that region of the casing which contains the release thread is exposed to the release temperature, the packaging contents are not or not appreciably impaired as a result of the heating. The heating of the release thread may take place by all means suitable for this purpose, for example by a hot-air jet, an infrared light source or ultrasound. The heating is expediently restricted to the necessary extent not only in time, but also locally. So that this is easily possible in the case of manual treatment, the release thread or that region of the casing which contains the release thread may be marked visually or in another way such that it can easily be detected by personnel or by machine.

In another group of forms of implementation, the release thread loses its strength as a result of the treatment to which the packaging contents, together with the packaging, are exposed. This is, in the case of sausage, in particular, boiling in a watery stock or smoking or drying in air. If the packaging contents have reached the required intrinsic strength even before this treatment, this treatment should lead, without delay, to the loss of strength of the release thread, unless the latter is still to remain on the product until sale. If, however, the intrinsic strength of the packaging contents occurs only during this treatment, it is necessary to ensure that at least an equivalent increase in the intrinsic strength of the packaging contents corresponds to the loss in strength of the release thread. This aim can easily be achieved by a suitable selection of material. If, for example, the strength of the release thread is based on the constituent soluble in the boiling stock of the sausage, the speed of release of the constituent is set so low that the release thread retains sufficient strength as long as this is required. The release thread may also be exposed deliberately to a chemical change, for example by means of acids or bases.

In a third group of forms of implementation, the release thread loses its strength as a result of time lapse under the prevailing treatment and storage conditions. For example, the release thread may consist of a material or contain a material which, in terms of the time elapsing from the production of the sausage to consumption, undergoes a calculatable aging process which will have led to the desired loss of strength at the foreseeable opening time. This process, as a rule, will not be independent of the treatment taking place in this period of time. For example, a release thread may be used, having an ingredient which is solid only in the presence of a high degree of moisture and loses strength during progressive drying. Proteins may be suitable for this purpose which are flexible and strong in the moist state and become brittle and cracked during drying and thereby lose their strength.

The release thread is incorporated into the knitted fabric in such a way that it connects two stitched rows which can be released from another in the event of a loss of its strength, with the result that the packaging as a whole is opened. Preferably, the release thread or the stitched row which is formed by it runs in the longitudinal direction of the elongate packaging casing or sausage casing. This shape is obtained, for example, when Raschel fabric is used as knitted fabric. However, a transverse run of the release thread may also lead to a satisfactory result. In most instances, it is sufficient if a packaging casing has in each case one release thread. Even a plurality of seams with release threads may be provided, however, which preferably run in the longitudinal direction and are at an approximately equal circumferential distance from one another.

It is not necessary for the release thread to lose its strength completely. It is sufficient if the latter is reduced to an extent such that the packaging portions which are connected by the release thread can be torn apart by the release thread being destroyed.

1. A packaging casing, in particular sausage casing, which comprises knitted fabric or contains the latter as a strengthening constituent and has at least one seam with a release thread, characterized in that the release thread loses its strength under the influence of a treatment compatible with the packaging contents or as a result of a time lapse.

2. The casing as claimed in claim 1, characterized in that it is a shape-determining casing net surrounding the actual sausage casing.

3. The casing as claimed in claim 1, characterized in that the release thread is temperature-sensitive.

4. The casing as claimed in claim 3, characterized in that the release thread is thermoplastic.

5. The casing as claimed in claim 1, characterized in that the loss in strength of the release thread is based on embrittlement.

6. The casing as claimed in claim 1, characterized in that the loss in strength of the release thread is based on the fact that the latter or an essential constituent is soluble in a treatment medium.

7. The casing as claimed in claim 1, characterized in that a plurality of the longitudinal seams with release thread are distributed over the circumference.

8. A method for opening a packaging casing, in particular sausage casing, which comprises a knitted fabric or contains the latter as a strengthening constituent and has at least one seam with a release thread, characterized in that, before opening, the loss in strength of the release thread is awaited, which takes place under the influence of a treatment compatible with the packaging contents or a result of a time lapse.

9. The method as claimed in claim 8, characterized in the release thread loses its strength at a release temperature which lies above the temperature of any treatment of the packaged packaging content and below a temperature at which the packaging contents may be damaged during the period of time required for releasing the release thread, and in that the release thread is heated to the release temperature in order to open the casing.

10. The method as claimed in claim 9, characterized in that the packaging contents, together with the packaging casing, are subjected to a treatment, as a result of which their dimensional stability grows and the strength of the release thread is reduced.

11. The method as claimed in claim 10, characterized in that the release thread contains a binding or softening constituent which is at least partially removed as a result of the treatment.

12. The method as claimed in claim 11, characterized in that the treatment is wet, and the release thread loses its strength at least partially as a result of the subsequent drying.

13. The casing as claimed in claim 2, characterized in that the release thread is temperature-sensitive.

14. The casing as claimed in claim 2, characterized in that the loss in strength of the release thread is based on embrittlement.

15. The casing as claimed in claim 3, characterized in that the loss in strength of the release thread is based on embrittlement.

16. The casing as claimed in claim 2, characterized in that the loss in strength of the release thread is based on the fact that the latter or an essential constituent is soluble in a treatment medium.

17. The casing as claimed in claim 2, characterized in that a plurality of the longitudinal seams with release thread are distributed over the circumference.

18. The casing as claimed in claim 3, characterized in that a plurality of the longitudinal seams with release thread are distributed over the circumference.

19. The casing as claimed in claim 4, characterized in that a plurality of the longitudinal seams with release thread are distributed over the circumference.

20. The casing as claimed in claim 5, characterized in that a plurality of the longitudinal seams with release thread are distributed over the circumference.
